(19) United States
(12) Patent Application Publication
(10) Pub. No.: US 2004/0157633 A1
(43) Pub. Date: Aug. 12, 2004

(54) Transmission power information generation module, radio communication apparatus, and transmission power information generation method

(76) Inventor: Miyuki Ogura, Tachikawa-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/386,485

(22) Filed: Mar. 13, 2003

(30) Foreign Application Priority Data
Feb. 7, 2003 (JP) 2003-030697

(51) Int. Cl. H04B 7/00; H04Q 7/20

(52) U.S. Cl. 455/522; 455/135; 455/69

(57) ABSTRACT

A decision part decides the target value of an SIR (signal to interference ratio) on the basis of the error rate of a reception signal. An SIR determination part determines an SIR regarding the reception signal in a predetermined determination cycle. A detection part detects an unconverged state in which the determined SIR does not converge on the decided target value within a period longer than the determination cycle. A correction part keeps the target value unchanged when no unconverged state is detected, and corrects the target value when the unconverged state is detected. A generation part generates transmission power information on the basis of the determined SIR and the output value of the correction part.

### CROSS-REFERENCE TO RELATED APPLICATIONS

This application is based upon and claims the benefit of priority from the prior Japanese Patent Application No. 2003-30697, filed Feb. 7, 2003, the entire contents of which are incorporated herein by reference.

### BACKGROUND OF THE INVENTION

1. Field of the Invention

The present invention relates to a radio communication apparatus used in a CDMA radio communication system such as a CDMA mobile communication system, and a transmission power information generation module and transmission power information generation method of generating transmission power information representing a proper transmission power for a communication partner in the radio communication apparatus.

2. Description of the Related Art

A near-far problem is known as a problem in practical use of the CDMA method. A technique of solving this near-far problem is disclosed in, e.g., Jpn. Pat. Appln. KOKAI Publication No. 2001-313605.

Jpn. Pat. Appln. KOKAI Publication No. 2001-313605 discloses a technique of controlling a downlink transmission power by a closed loop between a base station and a mobile station. To realize this transmission power control, the mobile station generates, for each slot, TPC information which requests to increase/decrease the downlink transmission power, and sends the TPC information to the base station. The base station increases/decreases the downlink transmission power on the basis of the TPC information.

The mobile station checks the signal to interference ratio (to be referred to as a reception SIR hereinafter) regarding a reception signal for each slot. The mobile station generates TPC information so as to make the reception SIR come close to a preset target value of SIR (to be referred to as a target SIR hereinafter).

The target SIR is an SIR necessary to satisfy a predetermined error rate. The SIR necessary to satisfy a predetermined error rate varies depending on the transmission channel status. Thus, the mobile station measures the error rate, and changes the target SIR so as to make the error rate come close to a predetermined error rate.

In a situation where a burst error occurs upon temporary degradation of the transmission channel quality, even an increase in downlink transmission power in the base station cannot recover the reception SIR in the mobile station. In the above-described arrangement, the target SIR is set higher as the error rate decreases. The mobile station may keep transmitting TPC information which requests to increase the downlink transmission power. In this case, the mobile station excessively requests the base station to increase the downlink transmission power, failing in appropriate transmission power control.

### BRIEF SUMMARY OF THE INVENTION

The present invention has been made in consideration of the above situation, and has as its object to optimize transmission power control.

According to one aspect of the present invention, the following transmission power information generation module is provided.

A transmission power information generation module configured to generate transmission power information representing a proper transmission power at a communication partner of a radio communication apparatus on the basis of a reception signal received by a CDMA radio communication apparatus, the module comprises a decision part configured to decide a target value of an SIR (signal to interference ratio) on the basis of an error rate of the reception signal, an SIR determination part configured to determine an SIR regarding the reception signal in a predetermined determination cycle, a detection part configured to detect an unconverged state in which the determined SIR does not converge on the decided target value within a predetermined period longer than the determination cycle, a correction part configured to keep the target value unchanged when no unconverged state is detected, and correct the target value when the unconverged state is detected, and a generation part configured to generate the transmission power information on the basis of the determined SIR and an output value of the correction part.

According to another aspect of the present invention, the following radio communication apparatus is provided.

A radio communication apparatus used in a CDMA radio communication system, the apparatus comprises a reception part configured to receive a signal of a predetermined channel contained in a CDMA radio signal, a decision part configured to decide a target value of an SIR (signal to interference ratio) on the basis of an error rate of the received signal, an SIR determination part configured to determine an SIR regarding the received signal in a predetermined determination cycle, a detection part configured to detect an unconverged state in which the determined SIR does not converge on the decided target value within a predetermined period longer than the determination cycle, a correction part configured to keep the target value unchanged when no unconverged state is detected, and correct the target value when the unconverged state is detected, a generation part configured to generate transmission power information on the basis of the determined SIR and an output value of the correction part, and a transmission part configured to transmit the generated the transmission power information to an apparatus which transmits the radio signal.

According to still another aspect of the present invention, the following transmission power information generation method is provided.

A transmission power information generation method of generating transmission power information representing a proper transmission power at a communication partner of a radio communication apparatus on the basis of a reception signal received by a CDMA radio communication apparatus, the method comprises deciding a target value of an SIR (signal to interference ratio) on the basis of an error rate of the reception signal, determining an SIR regarding the reception signal in a predetermined determination cycle, detecting an unconverged state in which the determined SIR does not converge on the decided target value within a predetermined period longer than the determination cycle, generating transmission power information on the basis of the determined SIR and the target value when no unconverged state is detected, and when the unconverged state is detected, correcting the target value and generating the transmission power information on the basis of the corrected target value and the determined SIR.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the arrangement of a radio communication apparatus according to the first embodiment of the present invention;

FIG. 2 is a block diagram showing the arrangement of a TPC module according to the first embodiment;

FIG. 3 is a view showing an example of an input/output signal in each unit of the TPC module;

FIG. 4 is a block diagram showing the arrangement of a TPC module according to the second embodiment of the present invention; and

FIG. 5 is a flow chart showing processing of a target SIR correction unit according to the second embodiment.

### DETAILED DESCRIPTION OF THE INVENTION

Preferred embodiments of the present invention will be described below with reference to the several views of the accompanying drawing.

(First Embodiment)

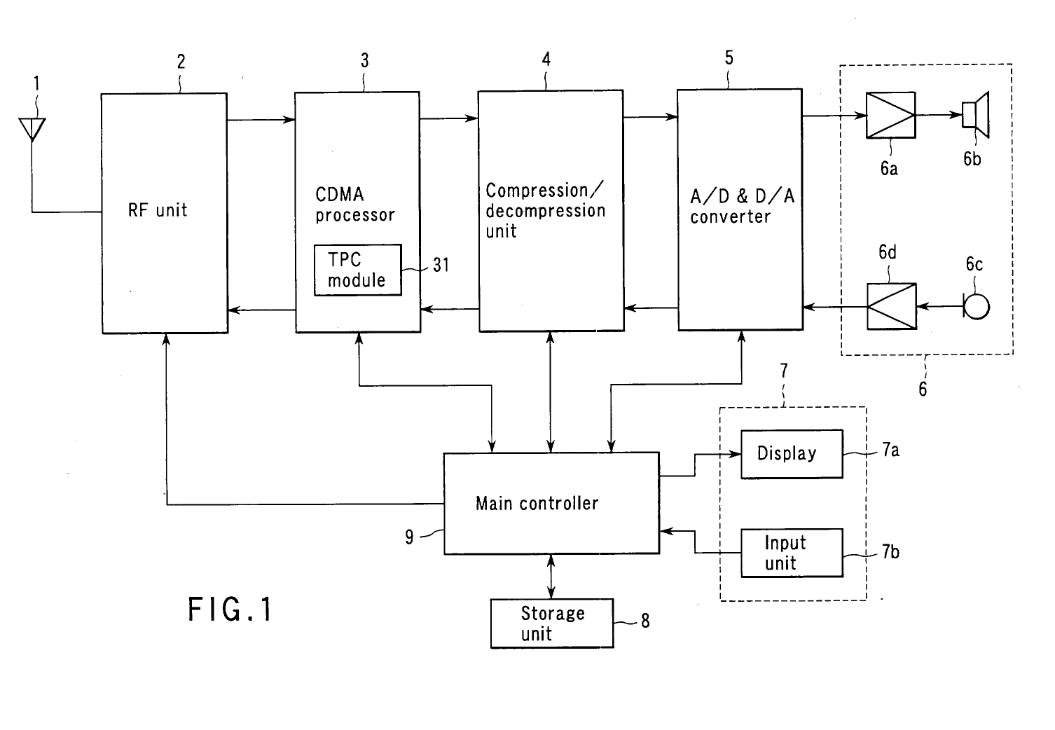

FIG. 1 is a block diagram showing the arrangement of a radio communication apparatus according to the first embodiment of the present invention. The radio communication apparatus of the first embodiment is adopted as a mobile station in a mobile radio communication system complying with the W-CDMA method defined by 3GPP (3rd Generation Partnership Project).

As shown in FIG. 1, the radio communication apparatus of the first embodiment comprises an antenna 1, an RF unit 2, a CDMA processor 3, a compression/decompression unit 4, an A/D & D/A converter 5, a speech communication unit 6, a user interface 7, a storage unit 8, and a main controller 9. The speech communication unit 6 includes an amplifier 6a, a loudspeaker 6b, a microphone 6c, and an amplifier 6d. The user interface 7 includes a display 7a and an input unit 7b.

A radio signal transmitted from a base station (not shown) is received by the antenna 1 and input to the RF unit 2. The RF unit 2 converts the frequency band of the signal output from the antenna 1 into a signal of a baseband or intermediate frequency band by a predetermined carrier frequency. The RF unit 2 executes filtering so as to limit the bandwidth of the frequency-converted signal to a predetermined bandwidth. The RF unit 2 amplifies the filtered signal to a predetermined level. The predetermined level is a level necessary to convert a signal into a digital signal having a predetermined number of bits. The signal having undergone these processes is input from the RF unit 2 to the CDMA processor 3.

The CDMA processor 3 sequentially performs A/D conversion, despreading, quadrature demodulation, deinterleaving, error correction, and error detection for the signal output from the RF unit 2. The CDMA processor 3 outputs reception data as a result of these processes.

The compression/decompression unit 4 performs, for the reception data output from the CDMA processor 3, decompression processing corresponding to a reception data rate notified from the main controller 9, and reproduces audio data of the baseband. The compression/decompression unit 4 supplies the audio data to the A/D & D/A converter 5.

The A/D & D/A converter 5 D/A-converts the audio data to obtain an audio signal. The audio signal is amplified by the amplifier 6a and output as speech from the loudspeaker 6b.

An utterance of the speaker is converted into an audio signal by the microphone 6c. The audio signal is input to the amplifier 6d. The audio signal is amplified to a proper level by the amplifier 6d, and supplied to the A/D & D/A converter 5.

The A/D & D/A converter 5 A/D-converts the audio signal to obtain audio data. The A/D & D/A converter 5 supplies the audio data to the compression/decompression unit 4.

The compression/decompression unit 4 compresses the audio data by AMR so as to change the audio data to a signal in a format corresponding to the data rate.

The CDMA processor 3 sequentially performs error correction encoding, interleaving, quadrature modulation, spread spectrum, and D/A conversion for data output from the compression/decompression unit 4. Also, the CDMA processor 3 inserts, into the signal, various pieces of control information to be sent to the base station. The control information includes TPC information. The CDMA processor 3 outputs a signal of a baseband or intermediate frequency band as a result of these processes.

The RF unit 2 converts the frequency band of the signal output from the CDMA processor 3 into a signal of a radio frequency band by a predetermined carrier frequency. The RF unit 2 executes filtering so as to limit the bandwidth of the frequency-converted signal to a predetermined bandwidth. The RF unit 2 amplifies the filtered signal to a predetermined level. The predetermined level is a level necessary for radio transmission. The signal having undergone these processes is supplied from the RF unit 2 to the antenna 1, which radiates the signal as radio waves.

The display 7a includes an LCD (Liquid Crystal Display) or LED (Light Emitting Diode). The display 7a uses the LCD or LED to display download information from a Web site, outgoing/incoming mail, moving pictures, and the discharge state of a battery (not shown), in addition to the operation state of the terminal of the user such as the telephone number of the terminal of a communication partner and a terminating state. The input unit 7b includes various keys. The input unit 7b receives a user instruction issued by pressing these keys.

The storage unit 8 properly includes a ROM, DRAM (Dynamic RAM), SRAM (Static RAM), or flash memory. The storage unit 8 stores operation programs for the main controller 9. The storage unit 8 stores various data such as various pieces of setting information, various reception data, or various data created by the apparatus.

The main controller 9 controls each unit by software processing based on operation programs stored in the storage unit 8, and implements the operation of a radio communication apparatus.

The CDMA processor 3 comprises a TPC module 31. The TPC module 31 generates TPC information used to control a downlink transmission power.

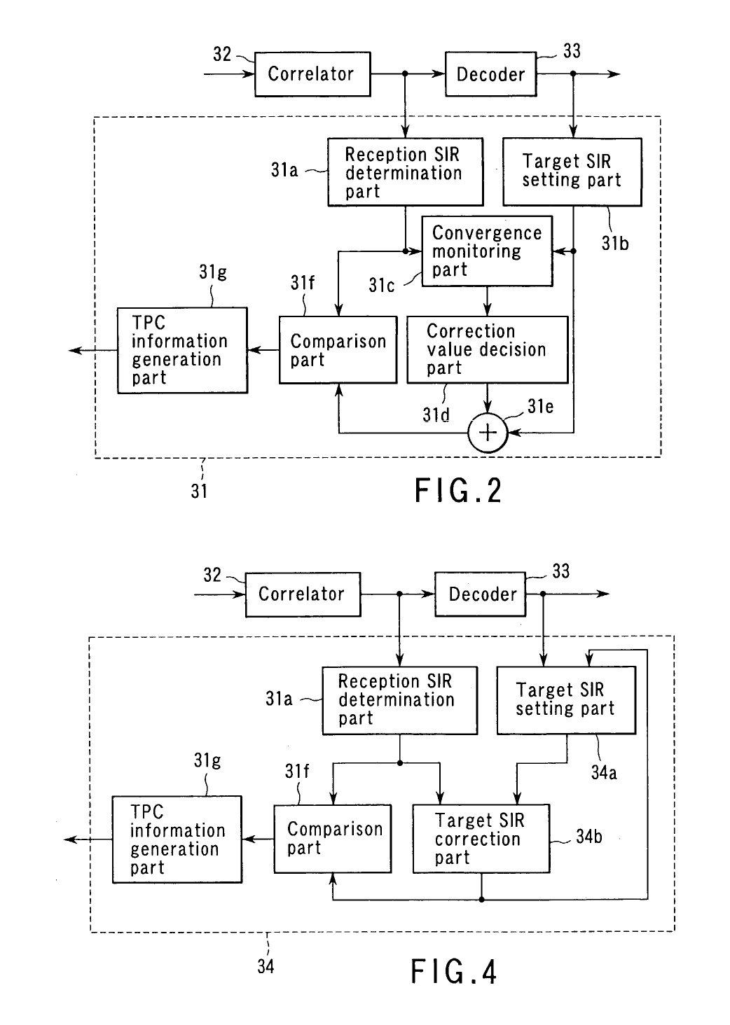

FIG. 2 is a block diagram showing the arrangement of the TPC module 31.

As shown in FIG. 2, the TPC module 31 includes a reception SIR determination part 31a, a target SIR setting part 31b, a convergence monitoring part 31c, a correction value decision part 31d, an addition part 31e, a comparison part 31f, and a TPC information generation part 31g.

A signal output from a correlator 32 is input to the reception SIR determination part 31a. A signal output from a decoder 33 is input to the target SIR setting part 31b. The correlator 32 and decoder 33 are incorporated in the CDMA processor 3.

The correlator 32 performs the above-mentioned despreading. More specifically, the correlator 32 receives a digital signal having a predetermined number of bits. The correlator 32 despreads the input signal by using a spreading code sequence reconstructed at a reception timing specified in advance by known cell search processing. Although not shown, the CDMA processor 3 includes a plurality of correlators 32.

The decoder 33 executes the above-mentioned quadrature demodulation, deinterleaving, error correction, and error detection. More specifically, the decoder 33 receives signals output from the correlators 32. The decoder 33 corrects the multipath delay distribution of the signals output from the correlators 32, and then synthesizes these signals. The decoder 33 converts the synthesized signal into binary information “1” or “0” by bit determination on the IQ plane. The decoder 33 performs interleaving, error correction, and error detection by known processing, and outputs reception data and reception CRC information.

The reception SIR determination part 31a determines a reception SIR regarding each channel of a reception signal for each slot (transmission power control cycle) on the basis of the signals output from the correlators 32.

The target SIR setting part 31b estimates a reception error rate on the basis of the reception CRC information output from the decoder 33. The target SIR setting part 31b compares the estimated reception error rate with a target error rate designated by the network side at the start of communication. The target SIR setting part 31b variably sets a target SIR as a value which makes the reception error rate come close to the target error rate.

The convergence monitoring part 31c averages the reception SIR over a period longer than a period corresponding to one slot, calculating an average SIR. The convergence monitoring part 31c calculates the difference value between the average SIR and the target SIR. The convergence monitoring part 31c monitors based on the difference value whether the reception SIR cannot converge to the target SIR (to be referred to as an unconverged state hereinafter). If the convergence monitoring part 31c detects the unconverted state, it instructs the correction value decision part 31d to output a correction value. At this time, the convergence monitoring part 31c notifies the correction value decision part 31d of the difference value.

The correction value decision part 31d starts output of a correction value in response to the instruction. The correction value decision part 31d decides a correction value on the basis of the difference value.

The addition part 31e adds the correction value to the target SIR, correcting the target SIR by the correction value. The addition part 31e outputs the corrected target SIR.

The comparison part 31f compares the reception SIR with the target SIR output from the addition part 31e. The comparison part 31f outputs the comparison result as binary information “0” or “1”.

The TPC information generation part 31g converts the signal output from the comparison part 31f into TPC information to be mapped into uplink signal control information.

The operation of the radio communication apparatus having the above arrangement according to the first embodiment will be explained. Note that the general operation of a mobile station in a W-CDMA mobile radio communication system is the same as that of an existing mobile station, and a description thereof will be omitted. An operation of generating TPC information by the TPC module 31 will be described in detail.

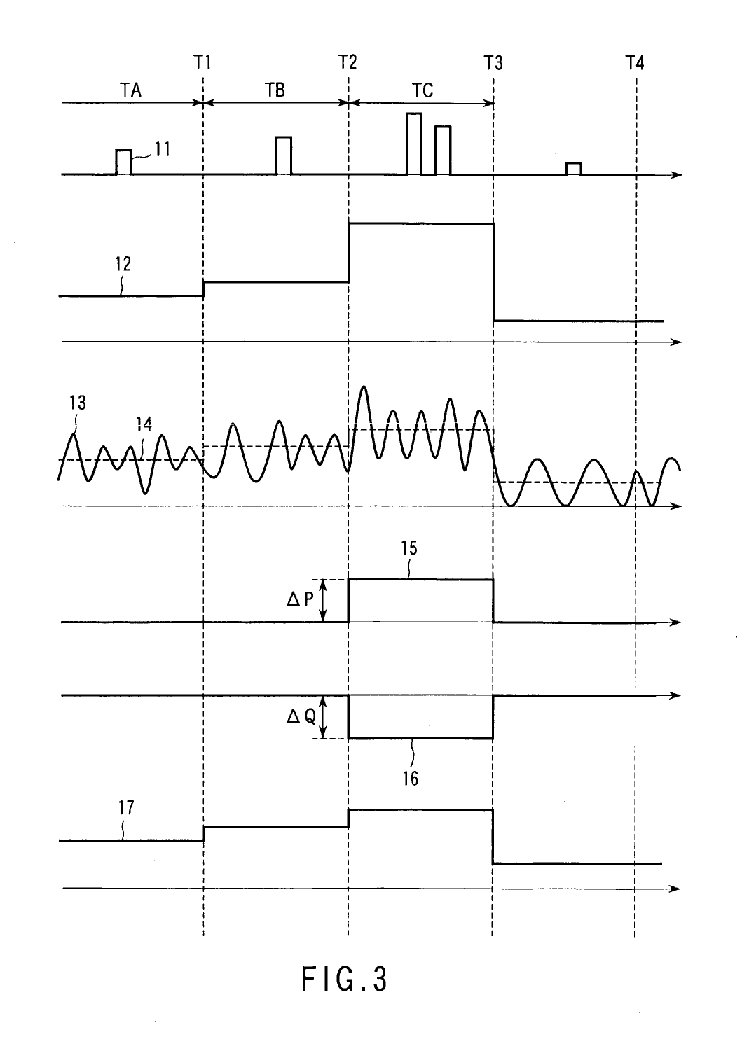

FIG. 3 is a view showing an example of an input/output signal in each unit of the TPC module 31.

In FIG. 3, a waveform 11 represents in time series the number of CRC errors given by reception CRC information input to the target SIR setting part 31b. A waveform 12 represents a change in target SIR output from the target SIR setting part 31b. A solid waveform 13 represents a change in reception SIR output from the reception SIR determination part 31a. A broken waveform 14 represents a change in average SIR calculated by the convergence monitoring part 31c. A waveform 15 represents a change in difference value calculated by the convergence monitoring part 31c. A waveform 16 represents a change in correction value output from the correction value decision part 31d. A waveform 17 represents a change in corrected target SIR output from the addition part 31e.

In FIG. 3, timings at which the target SIR setting part 31b sets the target SIR are times T1, T2, T3, and T4. The cycle during which the target SIR setting part 31b sets the target SIR suffices to comply with a target SIR setting algorithm, and may not have a periodicity, unlike the example shown in FIG. 3. Note that a delay time originally exists between the waveforms 11 and 12, but no delay is illustrated in FIG. 3 for descriptive convenience.

For example, during a period TA in FIG. 3, the correction value decision part 31d generally sets the correction value to “0”. At this time, a target SIR output from the target SIR setting part 31b is directly input to the comparison part 31f. Similar to the prior art, the comparison part 31f and TPC information generation part 31g generate TPC information on the basis of the magnitude relationship between a reception SIR determined by the reception SIR determination part 31a and the target SIR set by the target SIR setting part 31b.

At time T1 in FIG. 3, the target SIR set by the target SIR setting part 31b increases along with variations in the number of CRC errors. However, this target SIR change amount is small. During a period TB, the downlink transmission power is changed based on the TPC information generated in the above manner similarly to the prior art, and the reception SIR follows the target SIR. In this state, the difference value between the average SIR and the target SIR is small. If the difference value between the average SIR and the target SIR is smaller than a threshold, the convergence monitoring part 31c determines that the reception SIR follows the target SIR. In this case, the convergence monitoring part 31c does not instruct the correction value decision part 31d to output a correction value.

At time T2 in FIG. 3, the target SIR set by the target SIR setting part 31b greatly increases along with abrupt variations in the number of CRC errors. During a period TC, the reception SIR does not sufficiently follow the target SIR, and the average SIR is much lower than the target SIR. In this state, ΔP is generated as the difference value between the average SIR and the target SIR. If the difference value ΔP is equal to or larger than the threshold, the convergence monitoring part 31c determines that the reception SIR does not follow the target SIR. In this case, the convergence monitoring part 31c instructs the correction value decision part 31d to output a correction value. Also, the convergence monitoring part 31c notifies the correction value decision part 31d of the difference value ΔP. Upon reception of this instruction, the correction value decision part 31d outputs a correction value ΔQ based on the difference value ΔP. The difference value and correction value may have an arbitrary relationship. For example, the correction value=the difference value x (−1) may be adopted. This correction value may be multiplied by a proper coefficient. If the difference value is calculated by subtracting the target SIR from the average SIR, this difference value can be directly used as the correction value.

When the correction value decision part 31d outputs the correction value ΔQ, the addition part 31e adds the correction value ΔQ to the target SIR. That is, the target SIR is corrected by the correction value ΔQ. As represented by the waveform 17 in FIG. 3, the target SIR comes close to the average SIR during a period TC. The corrected target SIR is input to the comparison part 31f.

The comparison part 31f determines that the reception SIR follows the target SIR. This prevents generation of TPC information while the downlink transmission power is excessively changed. TPC information is normally generated during downlink transmission control for phasing follow-up.

As described above, the first embodiment can prevent any excessive transmission power increase request to the base station even under a reception condition in which the determination SIR does not follow the target SIR due to a burst error generated upon temporary degradation of the transmission channel quality. Any increase in interference with another mobile station can be avoided, and a high frequency utilization efficiency can be stably realized.

(Second Embodiment)

A radio communication apparatus according to the second embodiment has almost the same arrangement as that of the radio communication apparatus according to the first embodiment. The radio communication apparatus according to the second embodiment comprises a TPC module 34 with an arrangement as shown in FIG. 4, instead of the TPC module 31.

FIG. 4 is a block diagram showing the arrangement of the TPC module 34. In FIG. 4, the same reference numerals as in FIG. 2 denote the same parts, and a detailed description thereof will be omitted.

As shown in FIG. 4, the TPC module 34 includes a reception SIR determination part 31a, a comparison part 31f, a TPC information generation part 31g, a target SIR setting part 34a, and a target SIR correction part 34b.

The target SIR setting part 34a estimates a reception error rate on the basis of reception CRC information output from a decoder 33. The target SIR setting part 34b variably sets the target SIR in consideration of the estimated reception error rate, a target error rate designated by the network side at the start of communication, and a target SIR output by the target SIR correction part 34b at time immediately preceding by one cycle.

The target SIR correction part 34b includes, e.g., a processor. The target SIR correction part 34b receives a reception SIR output from the reception SIR determination part 31a and a target SIR output from the target SIR setting part 31b. The target SIR correction part 34b corrects the target SIR by the following processing. The target SIR correction part 34b supplies the corrected target SIR to the comparison part 31f.

The operation of the radio communication apparatus having the above arrangement according to the second embodiment will be explained.

The target SIR setting part 34a uses a target SIR output from the target SIR correction part 34b at time (k−1) immediately preceding by one cycle in order to control the criterion of a target SIR newly set at current time (k). The target SIR setting part 34a uses a reception error rate to control the difference from the criterion. That is, the target SIR setting part 34a reflects a target SIR output from the target SIR correction part 34b at time (k−1) as a newly set target SIR, and controls this value by a relative SIR amount obtained from the reception error rate.

More specifically, X represents a target SIR value output from the target SIR correction part 34b at time (k−1). ΔX represents an SIR increase/decrease value calculated from the reception error rate at time (k). The target SIR setting part 34a sets X as a criterion, and then sets a target SIR at time (k) as a value considering the increase/decrease value ΔX. Hence, the target SIR setting part 34a sets the target SIR at time (k) as a value X+ΔX.

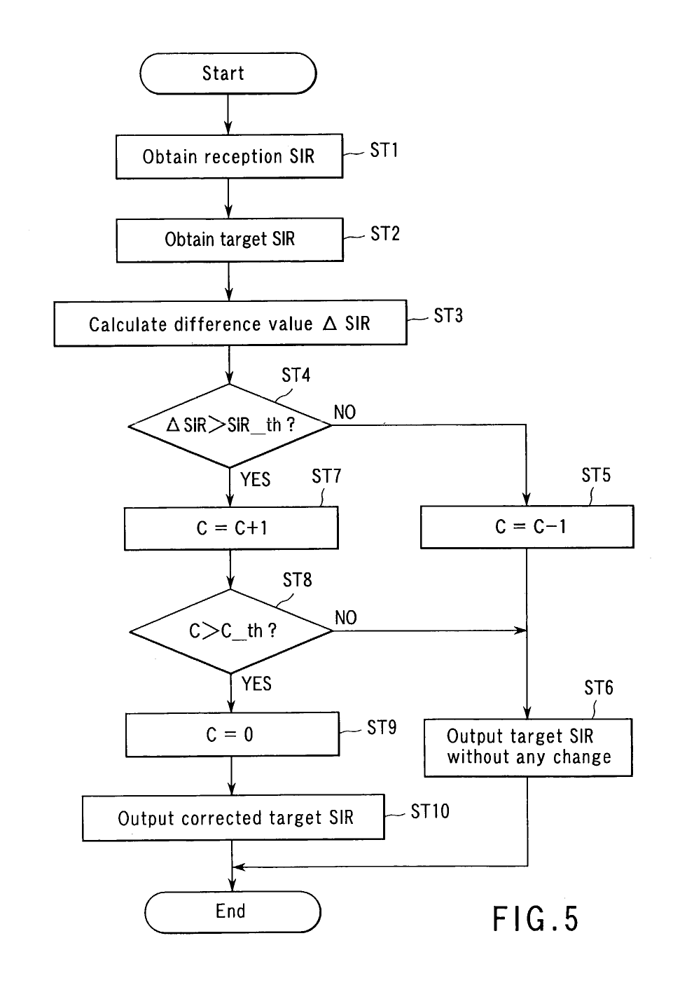

FIG. 5 is a flow chart showing processing of the target SIR correction part 34b. The target SIR correction part 34b executes processing shown in FIG. 5 for each slot.

In step ST1, as shown in FIG. 5, the target SIR correction part 34b obtains a reception SIR output from the reception SIR determination part 31a. The reception SIR determination part 31a determines the reception SIR for each slot in order to reflect a determination result on uplink transmission power control information mapped in an uplink slot format. In step ST1, the target SIR correction part 34b obtains a new reception SIR determined for each slot. In step ST2, the target SIR correction part 34b obtains a target SIR output from the target SIR setting part 34a. In step ST3, the target SIR correction part 34b calculates a difference value ΔSIR of the reception SIR from the target SIR.

In step ST4, the target SIR correction part 34b checks whether the difference value ΔSIR is larger than a threshold SIR_th. If “No” in step ST4, the target SIR correction part 34b decrements a count value C by one in step ST5. In step ST6, the target SIR correction part 34b outputs the target SIR obtained in step ST2 without any change. In other words, if the difference of the reception SIR from the target SIR is small, the target SIR correction part 34b determines that the reception SIR has converged on the target SIR. In this case, the target SIR correction part 34b supplies the target SIR output from the target SIR setting part 31b to the comparison part 31f without any correction.

If “Yes” in step ST4, the target SIR correction part 34b increments the count value C by one in step ST7. In this way, the count value C is incremented by one when the difference value ΔSIR is larger than the threshold SIR_th, and decremented by one when the difference value ΔSIR is equal to or smaller than the threshold SIR_th. The count value C represents a larger numerical value for a higher frequency at which the difference value ΔSIR is larger than the threshold SIR_th.

In step ST8, the target SIR correction part 34b checks whether the incremented count value C is larger than a threshold C_th. If “No” in step ST8, the target SIR correction part 34b outputs in step ST6 the target SIR obtained in step ST2 without any change. If the difference of the reception SIR from the target SIR is large at a low frequency, the target SIR correction part 34b determines that the reception SIR has converged on the target SIR. In this case, the target SIR correction part 34b supplies the target SIR output from the target SIR setting part 31b to the comparison part 31f without any correction.

If “Yes” in step ST8, the target SIR correction part 34b clears the count value C to “0” in step ST9. In step ST10, the target SIR correction part 34b corrects the target SIR and outputs the corrected target SIR. The target SIR can be corrected similarly to the first embodiment. That is, if the difference of the reception SIR from the target SIR is large at a high frequency, the target SIR correction part 34b determines that the reception SIR cannot converge on the target SIR. Thus, the target SIR correction part 34b supplies the corrected target SIR to the comparison part 31f.

Note that the thresholds SIR_th and C_th are set to proper values in advance in consideration of the determination error of the reception SIR by the reception SIR determination part 31a, the response characteristics of inner loop control and outer loop control, and the like.

As described above, the second embodiment can prevent any excessive transmission power increase request to the base station even under a reception condition in which the determination SIR does not follow the target SIR due to a burst error generated upon temporary degradation of the transmission channel quality. Any increase in interference with another mobile station can be avoided, and a high frequency utilization efficiency can be stably realized.

The present invention is not limited to the above embodiments. For example, the target SIR can be corrected by another method. For example, a target SIR output from the target SIR setting part 31b immediately before the reception SIR is determined not to converge on the target SIR is stored. The stored target SIR is employed as a corrected target SIR. As another method, target SIRs output from the target SIR setting part 31b while the reception SIR is determined to converge on the target SIR are collected over a long period. A proper target SIR is estimated based on the collected target SIRs. This estimation can adopt a method of averaging collected target SIRs, or a learning method which considers information such as the temporal factor, moving speed, or reception multipath state.

In the second embodiment, a method of measuring the frequency at which the difference value ΔSIR becomes larger than the threshold SIR_th can be appropriately changed. For example, the count at which the difference value ΔSIR becomes larger than the threshold SIR_th within a predetermined period is counted. As still another method, the count at which the difference value ΔSIR becomes larger than the threshold SIR_th, and the count at which the difference value ΔSIR becomes equal to or smaller than the threshold SIR_th are individually counted to calculate the ratio of these count values.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A transmission power information generation module configured to generate transmission power information representing a proper transmission power at a communication partner of a radio communication apparatus on the basis of a reception signal received by a CDMA radio communication apparatus, the module comprising:
a decision part configured to decide a target value of an SIR (signal to interference ratio) on the basis of an error rate of the reception signal;
an SIR determination part configured to determine an SIR regarding the reception signal in a predetermined determination cycle;
a detection part configured to detect an unconverged state in which the determined SIR does not converge on the decided target value within a predetermined period longer than the determination cycle;
a correction part configured to keep the target value unchanged when no unconverged state is detected, and correct the target value when the unconverged state is detected; and
a generation part configured to generate the transmission power information on the basis of the determined SIR and an output value of the correction part.

2. The transmission power information generation module according to claim 1, wherein the detection part comprises
an average calculation part configured to calculate an average value of the SIR determined by the SIR determination part in the predetermined period,
a difference calculation part configured to calculate a difference value between the calculated average value and the decided target value, and
a determination part configured to determine the unconverged state when the calculated difference value is not smaller than a threshold.

3. The transmission power information generation module according to claim 1, wherein the detection part comprises
a difference calculation part configured to calculate a difference value between the determined SIR and the decided target value,
a frequency measurement part configured to measure a frequency at which the calculated difference value becomes not smaller than a first threshold, and
a determination part configured to determine the unconverged state when the measured frequency becomes not smaller than a second threshold.

4. The transmission power information generation module according to claim 1, wherein the correction part decides a correction value on the basis of the target value decided in a past period in which no unconverged state is detected, and replaces a newly decided target value with the correction value.

5. A radio communication apparatus used in a CDMA radio communication system, the apparatus comprising:
a reception part configured to receive a signal of a predetermined channel contained in a CDMA radio signal;
a decision part configured to decide a target value of an SIR (signal to interference ratio) on the basis of an error rate of the received signal;
an SIR determination part configured to determine an SIR regarding the received signal in a predetermined determination cycle;
a detection part configured to detect an unconverged state in which the determined SIR does not converge on the decided target value within a predetermined period longer than the determination cycle;
a correction part configured to keep the target value unchanged when no unconverged state is detected, and correct the target value when the unconverged state is detected;
a generation part configured to generate the transmission power information on the basis of the determined SIR and an output value of the correction part; and
a transmission part configured to transmit the generated transmission power information to an apparatus which transmits the radio signal.

6. An apparatus according to claim 5, wherein the detection part comprises
an average calculation part configured to calculate an average value of the SIR determined by the SIR determination part in the predetermined period,
a difference calculation part configured to calculate a difference value between the calculated average value and the decided target value, and
a determination part configured to determine the unconverged state when the calculated difference value
is not smaller than a threshold.

7. The radio communication apparatus according to claim 5, wherein the detection part comprises
a difference calculation part configured to calculate a difference value between the determined SIR and the decided target value,
a frequency measurement part configured to measure a frequency at which the calculated difference value becomes not smaller than a first threshold, and
a determination part configured to determine the unconverged state when the measured frequency becomes not smaller than a second threshold.

8. The radio communication apparatus according to claim 5, wherein the correction part decides a correction value on the basis of the target value decided in a past period in which no unconverged state is detected, and replaces a newly decided target value with the correction value.

9. A transmission power information generation method of generating transmission power information representing a proper transmission power at a communication partner of a radio communication apparatus on the basis of a reception signal received by a CDMA radio communication apparatus, the method comprising:
deciding a target value of an SIR (signal to interference ratio) on the basis of an error rate of the reception signal;
determining an SIR regarding the reception signal in a predetermined determination cycle;
detecting an unconverged state in which the determined SIR does not converge on the decided target value within a predetermine period longer than the determination cycle;
generating the transmission power information on the basis of the determined SIR and the target value when no unconverged state is detected; and
when the unconverged state is detected, correcting the target value and generating transmission power information on the basis of the corrected target value and the determined SIR.
